(19) United States
(12) Patent Application Publication
(10) Pub. No.: US 2013/0017551 A1
(43) Pub. Date: Jan. 17, 2013

(54) COMPUTATION OF REAL-WORLD ERROR USING META-ANALYSIS OF REPLICATES

(71) Applicant: Simant Dube, Pleasanton, CA (US)

(72) Inventor: Simant Dube, Pleasanton, CA (US)

(73) Assignee: BIO-RAD LABORATORIES, INC., Hercules, CA (US)

(21) Appl. No.: 13/549,360

(22) Filed: Jul. 13, 2012

Related U.S. Application Data
(60) Provisional application No. 61/507,560, filed on Jul. 13, 2011.

(51) Int. Cl. G06F 19/10; G01N 21/76

(52) U.S. Cl. 435/6.12; 435/287.2; 702/19

(57) ABSTRACT

A system, including methods and apparatus, for performing a digital assay on a number of sample-containing replicates, each containing a plurality of sample-containing droplets, and measuring the concentration of target in the sample. Statistical meta-analysis techniques may be applied to reduce the effective variance of the measured target concentration.

### CROSS-REFERENCES TO PRIORITY APPLICATION

This application is based upon and claims the benefit under 35 U.S.C. §119(e) of U.S. Provisional Patent Application Ser. No. 61/507,560, filed Jul. 13, 2011, which is incorporated herein by reference in its entirety for all purposes.

### CROSS-REFERENCES TO OTHER MATERIALS

This application incorporates by reference in their entireties for all purposes the following materials: U.S. Pat. No. 7,041,481, issued May 9, 2006; U.S. Patent Application Publication No. 2010/0173394 A1, published Jul. 8, 2010; PCT Patent Application Publication No. WO 2011/120006 A1, published Sep. 29, 2011; PCT Patent Application Publication No. WO 2011/120024 A1, published Sep. 29, 2011; U.S. patent application Ser. No. 13/287,120, filed Nov., 1, 2011; U.S. Provisional Patent Application Ser. No. 61/507,082, filed Jul. 12, 2011; U.S. Provisional Patent Application Ser. No. 61/510,013, filed Jul. 20, 2011; and Joseph R. Lakowicz, PRINCIPLES OF PHOTOLUMINESCENCE SPECTROSCOPY (2^{nd} Ed. 1999).

### INTRODUCTION

Digital assays generally rely on the ability to detect the presence or activity of individual copies of an analyte in a sample. In an exemplary digital assay, a sample is separated into a set of partitions, generally of equal volume, with each containing, on average, less than about one copy of the analyte. If the copies of the analyte are distributed randomly among the partitions, some partitions should contain no copies, others only one copy, and, if the number of partitions is large enough, still others should contain two copies, three copies, and even higher numbers of copies. The probability of finding exactly 0, 1, 2, 3, or more copies in a partition, based on a given average concentration of analyte in the partitions, is described by a Poisson distribution. Conversely, the concentration of analyte in the partitions (and thus in the sample) may be estimated from the probability of finding a given number of copies in a partition.

Estimates of the probability of finding no copies and of finding one or more copies may be measured in the digital assay. Each partition can be tested to determine whether the partition is a positive partition that contains at least one copy of the analyte, or is a negative partition that contains no copies of the analyte. The probability of finding no copies in a partition can be approximated by the fraction of partitions tested that are negative (the “negative fraction”), and the probability of finding at least one copy by the fraction of partitions tested that are positive (the “positive fraction”). The positive fraction or the negative fraction then may be utilized in a Poisson equation to determine the concentration of the analyte in the partitions.

Digital assays frequently rely on amplification of a nucleic acid target in partitions to enable detection of a single copy of an analyte. Amplification may be conducted via the polymerase chain reaction (PCR), to achieve a digital PCR assay. The target amplified may be the analyte itself or a surrogate for the analyte generated before or after formation of the partitions. Amplification of the target can be detected using any suitable method, such as optically from a photoluminescent (e.g., fluorescent or phosphorescent) probe included in the reaction. In particular, the probe can include a dye that provides a photoluminescence (e.g., fluorescence or phosphorescence) signal indicating whether or not the target has been amplified.

In a digital assay of the type described above, it is expected that there will be data, at least including photoluminescence intensity, available for each of a relatively large number of sample-containing droplets. This will generally include thousands, tens of thousands, hundreds of thousands of droplets, or more. Statistical tools generally may be applicable to analyzing this data. For example, statistical techniques may be applied to determine, with a certain confidence level, whether or not any targets were present in the unamplified sample. This information may in some cases be extracted simply in the form of a digital (“yes or no”) result, whereas in other cases, it also may be desirable to determine an estimate of the concentration of target in the sample, i.e., the number of copies of a target per unit volume.

Using statistical methods, it is possible to estimate target concentration even when the droplet volumes are unknown and no parameter is measured that allows a direct determination of droplet volume. More specifically, because the targets are assumed to be randomly distributed within the droplets, the probability of a particular droplet containing a certain number of copies of a target may be modeled by a Poisson distribution function, with droplet concentration as one of the parameters of the function.

Due to measurement errors, the measured variance of target concentration may exceed the expected Poisson variance. In other words, in addition to statistical variance, the measurement of target concentration may be characterized by a certain amount of “real-world” measurement error. Sources of such real-world measurement errors may include, for example, pipetting errors, fluctuations associated with droplet generation and handling (e.g., droplet size, droplet separation, droplet flow rate, etc.), fluctuations associated with the light source (e.g., intensity, spectral profile, etc.), fluctuations associated with the detector (e.g., threshold, gain, noise, etc.), and contaminants (e.g., non-sample-derived targets, inhibitors, etc.), among others. These errors may undesirably decrease the confidence level of a particular target concentration estimate, or equivalently, increase the confidence interval for a given confidence level.

Accordingly, a new approach is needed that would effectively decrease the variance of target concentration.

### SUMMARY

The present disclosure provides a system, including methods and apparatus, for performing a digital assay on a number of sample-containing replicates, each containing a plurality of sample-containing droplets, and measuring the concentration of target in the sample. Statistical meta-analysis techniques may be applied to reduce the effective variance of the measured target concentration.

### BRIEF DESCRIPTION OF THE DRAWINGS

FIG. 1 is a schematic depiction of target concentration data based on a plurality of sample-containing replicates, in accordance with aspects of the present disclosure.

FIG. 2 is a flow chart depicting a method of generating a meta-replicate having improved statistical properties, in accordance with aspects of the present disclosure.

FIG. 3 is a schematic diagram depicting a system for estimating target concentration in a sample-containing fluid, in accordance with aspects of the present disclosure.

FIG. 4 is a flow chart depicting a method of reducing effective statistical variance of a concentration of target in a digital assay, in accordance with aspects of the present disclosure.

FIG. 5 is a histogram showing exemplary experimental data in which the number of detected droplets is plotted as a function of a measure of fluorescence intensity, in accordance with aspects of the present disclosure.

### DETAILED DESCRIPTION

The present disclosure provides a system, including methods and apparatus, for performing a digital assay on a sample. The system may include dividing the sample into a number of replicates, each containing a plurality of sample-containing droplets, and measuring the concentration of target in the sample. Statistical meta-analysis techniques may be applied to reduce the effective variance of the measured target concentration.

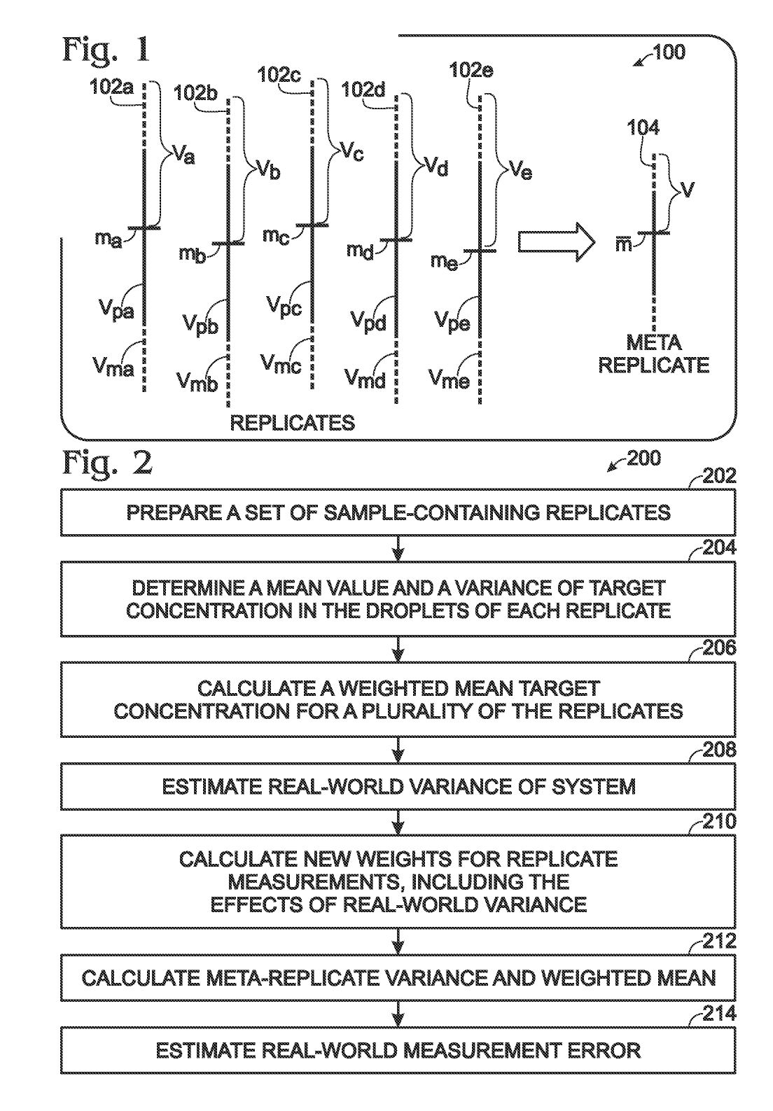

FIG. 1 schematically depicts a set of target concentration measurements, generally indicated at 100, according to aspects of the present teachings. A sample, such as a sample fluid, may be separated into a plurality of partitions, each containing many sample-containing droplets. For example, a particular sample fluid may be placed in a plurality of sample wells and each sample well processed and analyzed separately to determine an estimate of target molecule concentration within that well. In this case, the wells (or other containers) containing the same sample fluid may be referred to as “replicates” or “replicate wells.” Because each replicate is expected to contain a large number of sample-containing droplets, the presence of target within the droplets may be characterized by a slightly different Poisson distribution function for each replicate, including a different mean and variance. The left-hand side of FIG. 1 depicts a plurality of target concentration measurements based on a plurality of replicates 102a, 102b, 102c, 102d, and 102e (collectively, replicates 102), each containing a number of sample-containing droplets. These replicates 102 are characterized by the fact that they each contain some amount of the same sample-containing fluid, so that the target concentration within the droplets of each replicate 102 is expected to be the same within statistical limits. The right-hand side of FIG. 1 depicts properties of a “meta-replicate” 104. As described in more detail below, meta-replicate 104 is a fictitious replicate based on replicates 102, but with improved statistical features.

The droplets in replicates 102 will typically be aqueous droplets associated with an oil, for example, to form an emulsion, although the present teachings are generally applicable to any collections of sample-containing droplets and/or other partitions. Because target are assumed to be randomly distributed within the droplets of replicates 102, the probability of a particular droplet containing a certain number of copies of a target may be modeled by a Poisson distribution function, with droplet concentration as one of the parameters of the function. Accordingly, a mean value and a variance of droplet concentration may be extracted from the distribution function for each replicate. The mean concentration values for each replicate 102 are depicted in FIG. 1 as mₐ, m_{b}, m_{c}, m_{d}, mₑ, respectively.

In a system with no real-world measurement error, the variance of a Poisson distribution function is equal to its mean value. More generally, however, the total measured concentration variance and vₐ, v_{b}, v_{c}, v_{d}, vₑ corresponding to each replicate includes both the Poisson variance vₚ (denoted in FIG. 1 as vₚₐ, v_{pb}, v_{pc}, v_{pd}, vₚₑ) and some measurement error variance vₘ (denoted in FIG. 1 as vₘₐ, v_{mb}, v_{mc}, v_{md}, vₘₑ).

This may increase the total variance to an undesirable level, and fails to take statistical advantage of the presence of multiple replicates. However, as described below, statistical meta-analysis techniques may be applied to reduce the effective variance of the measured target concentration, resulting in a meta-replicate 104 having a mean concentration value m̅ and a variance v that is smaller than the variance of any of the individual replicates. Furthermore, also as described below, meta-analysis may allow the amount of real-world measurement error to be determined.

FIG. 2 is a flow chart depicting a method, generally indicated at 200, of generating a fictitious meta-replicate corresponding to a plurality of sample-containing replicates and having improved statistical properties compared to the individual replicates, according to aspects of the present teachings.

At step 202, a set of replicates is prepared. This may include preparing a sample-containing fluid, generating an emulsion of sample-containing droplets, adding appropriate polymerase chain reaction reagents and photoluminescent reporters, and/or DNA amplification, among others. Exemplary techniques to prepare sample-containing replicates for nucleic acid amplification are described, for example, in the following patent documents, which are incorporated herein by reference: U.S. Patent Application Publication No. 2010/0173394 A1, published Jul. 8, 2010; and U.S. patent application Ser. No. 12/976,827, filed Dec. 22, 2010. Replicates may be prepared by forming copies, such as two, three, four, or more copies, of the same complete reaction mixture, for example, in separate wells or other containers.

At step 204, a mean value and a variance of the target concentration in the droplets of each replicate is determined. This generally includes measuring the photoluminescence of each sample-containing droplet within a replicate, determining the target concentration in each droplet based on the measured photoluminescence, and then extracting the mean and variance of the concentration under the assumption that the target concentration follows a particular distribution function such as a Poisson distribution function. Exemplary techniques to estimate the mean and variance of target concentration in a plurality of sample-containing droplets are described, for example, in the following patent documents, which are incorporated herein by reference: U.S. Provisional Patent Application Ser. No. 61/277,216, filed Sep. 21, 2009; and U.S. Patent Application Publication No. 2010/0173394 A1, published Jul. 8, 2010.

At step 206, a weighted mean target concentration is calculated for the combination of all (or a plurality) of the replicates. More specifically, consider k replicates with individual mean concentrations m₁, m₂, . . . , mₖ and Poisson variances v₁, v₂, . . . , vₖ, respectively. We define a weight of replicate i as the reciprocal of its variance:

$${w}_{i} = \frac{1}{{v}_{i}} \qquad ( 1 )$$

Here, replicates with relatively smaller variances have a greater weight than replicates with relatively larger variances. Then m̅, the weighted mean target concentration, is as follows:

$$\overline{m} = \frac{{\sum }_{i = 1}^{k} {w}_{i} {m}_{i}}{{\sum }_{i = 1}^{k} {w}_{i}} \qquad ( 2 )$$

Here, replicates with relatively greater weights (i.e., smaller variances) contribute more than replicates with relatively lesser weights (i.e., larger variances).

At step 208, the real-world variance is estimated for the system, based on deviations of the mean concentration determined for each replicate from the weighted mean concentration for the plurality of replicates. This is accomplished as follows. A random variable is defined that measures the fluctuation of concentrations around the weighted mean:

T=Σᵢ₌₁^{k}wᵢ(mᵢ− m̅)² (3)

T is a sum of the squares of approximately standard normal random variables, and therefore can be approximated as a chi-square distribution. The mean of the distribution is the number of degrees of freedom df=k−1. If T is less than df, we say that there is no additional real-world variance. If T is more than df, then this suggests there is additional real-world variance r=T−df.

At step 210, new weights for the replicate measurements are calculated, including the effects of the real-world variance. More specifically, because Tis based on standard normal variables, we scale back r to r′ in original units after applying an appropriate correction factor:

$${r}^{′} = \frac{r}{\sum {w}_{i} - \frac{\sum {w}_{i}^{2}}{\sum {w}_{i}}} \qquad ( 4 )$$

We can add r′ to the Poisson variance to give the total variance for each replicate. We then redefine the weight of each replicate as follows:

$${w}_{i}^{′} = \frac{1}{{v}_{i} + {r}^{′}} \qquad ( 5 )$$

At step 212, a new variance and weighted mean are calculated for the meta-replicate based on the redefined weights:

$$\begin{matrix}{v}^{′} = \frac{1}{Σ {w}_{i}^{′}} & ( 6 ) \\ {\overline{m}}^{′} = \frac{{\sum }_{i = 1}^{k} {w}_{i}^{′} {m}_{i}}{{\sum }_{i = 1}^{k} {w}_{i}^{′}} & ( 7 )\end{matrix}$$

At step 214, the real-world measurement error may be estimated. Specifically, by setting r′ to zero, we can estimate the variance of the meta-data in the presence of only Poisson error. Comparing this to the variance estimate including real-world error allows the variance due to real-world error to be estimated.

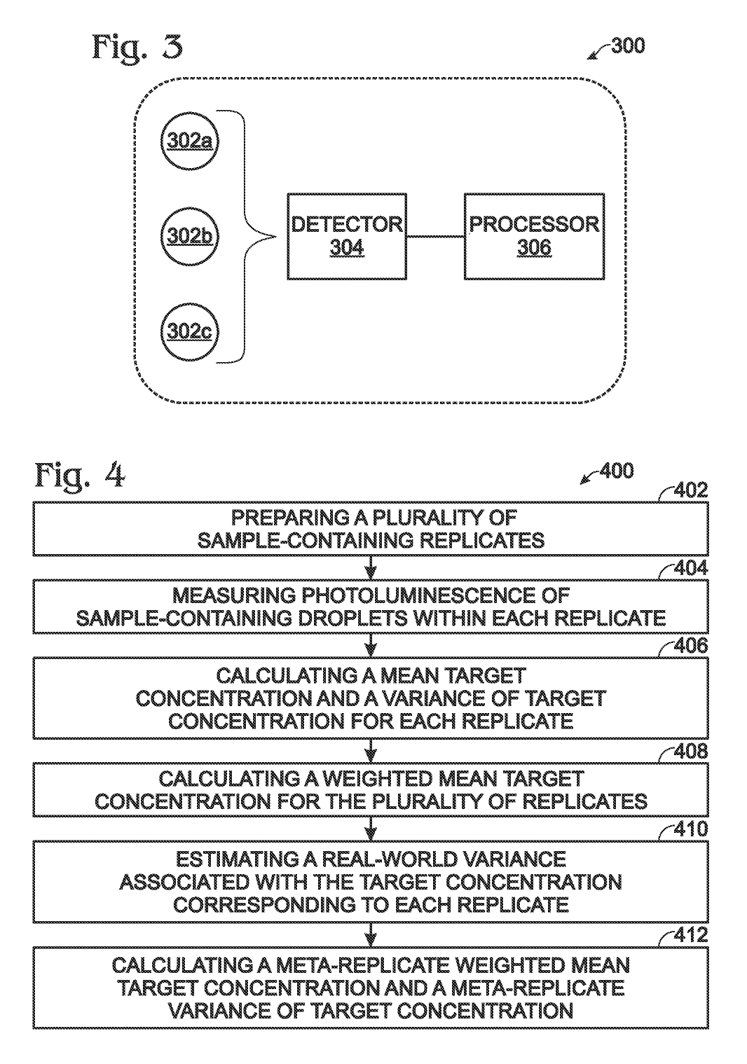

FIG. 3 is a schematic diagram depicting a system, generally indicated at 300, for estimating target concentration in a sample-containing fluid, in accordance with aspects of the present disclosure. System 300 includes a plurality of replicates 302a, 302b, 302c, each containing a plurality of sample-containing droplets, for example, suspended in or otherwise associated with a background fluid. Although three replicates are depicted in FIG. 3, any number of two or more replicates may be used in conjunction with the present teachings.

System 300 also includes a detector 304 configured to measure photoluminescence emitted by the droplets contained in the replicates. The present teachings do not require any particular type of photoluminescence detector, and therefore, detector 304 will not be described in more detail. Detectors suitable for use in conjunction with the present teachings are described, for example, in U.S. Provisional Patent Application Ser. No. 61/277,203, filed Sep. 21, 2009; U.S. Patent Application Publication No. 2010/0173394 A1, published Jul. 8, 2010; U.S. Provisional Patent Application Ser. No. 61/317,684, filed Mar. 25, 2010; and PCT Patent Application Serial No. PCT/US2011/030077, filed Mar. 25, 2011.

System 300 further includes a processor 306 configured to calculate a meta-replicate mean target concentration value and a meta-replicate variance of target concentration. Processor 306 may accomplish this calculation by performing some or all of the steps described above with respect to method 200. More specifically, processor 306 may be configured to determine, based on photoluminescence measurements of the detector, a mean target concentration and a total variance of target concentration for the droplets of each replicate, to estimate a real-world variance of the target concentration, and to calculate a meta-replicate mean target concentration value and a meta-replicate variance of target concentration based on the estimated real-world variance.

Determining the meta-replicate properties may include various other processing steps. For example, processor 306 may be further configured to calculate a weighted mean target concentration for the replicates, and to estimate the real-world variance of the target concentration by calculating target concentration fluctuations around the weighted mean. In addition, processor 306 may be configured to calculate revised weights for each replicate based on the estimated real-world variance, and to calculate the meta-replicate mean target concentration value and the meta-replicate variance of target concentration using the revised weights. Furthermore, processor 306 may be configured to estimate the meta-replicate variance of target concentration in the presence of only Poisson error, and to estimate the variance of target concentration due to real-world error by comparing the variance estimate in the presence of only Poisson error to the variance estimate including real-world error.

FIG. 4 is a flowchart depicting a method, generally indicated at 400, of reducing effective statistical variance of a concentration of target in a digital assay.

At step 402, method 400 includes preparing a plurality of replicates, each containing a known or same amount of a sample-containing fluid. As described previously, a sample-containing fluid according to the present teachings may include, for example, aqueous sample-containing droplets associated with an oil, for example, to form an oil emulsion.

At step 404, method 400 includes measuring the photoluminescence of the sample-containing droplets within each of the replicates. Photoluminescence emitted by a particular sample-containing droplet may indicate, for example, whether or not a nucleic acid target is present in the droplet and has been amplified through polymerase chain reaction. In some cases, as noted previously, the sample-containing droplets may have unknown volumes, whereas in other cases the droplet volumes may be known or estimated independently of the photoluminescence measurement.

At step 406, method 400 includes calculating a mean target concentration and a variance of target concentration for each replicate, based on the presence or absence of target in each droplet of the replicate, as indicated by the measured photoluminescence of droplets within the replicate. This can be accomplished, for example, by assuming that the target concentration within the droplets follows a particular distribution function, such as a Poisson distribution function.

Exemplary techniques for estimating the mean target concentration within a replicate will now be described. These techniques assume that a collection of values representing the photoluminescence intensity for each droplet is available. The techniques described can be applied to peak photoluminescence data (i.e., the maximum photoluminescence intensity emitted by a droplet containing a particular number of copies of a target), but are not limited to this type of data. The described techniques may be generalized to any measurements that could be used to distinguish target-containing droplets from empty droplets.

If m is the target concentration of a sample (number of copies of a target per unit volume), V_{d} is the volume of a droplet (assumed constant in this example), and λ=mV_{d} is the average number of target copies per droplet, the probability that a given droplet will contain k target molecules is given by the Poisson distribution:

$$P ( k ; λ ) = \frac{{λ}^{k} Exp ( - λ )}{k !} \qquad ( 8 )$$

If, for example, there is an average of 3 copies of target nucleic acid per droplet, Poisson's distribution would indicate that an expected 5.0% of droplets would have zero copies, 14.9% would have one copy, 22.4% would have 2 copies, 22.4% would have 3 copies, 16.8% would have 4 copies, and so on. It can be reasonably assumed that a droplet will react if there is one or more target nucleic acid molecules in the volume. In total, 95% of the droplets should be positive, with 5% negative. Because the different numbers of initial copies per droplet can, in general, be distinguished after amplification, a general description of the analysis taking this into account can provide improved accuracy in calculating concentration.

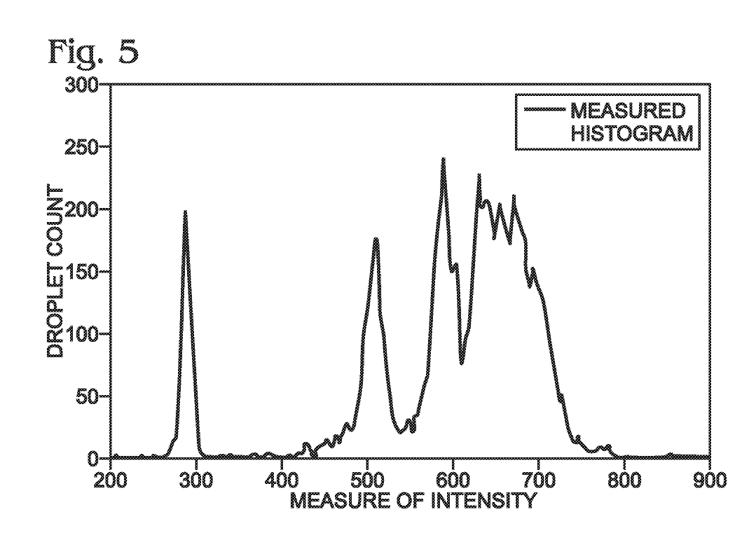

FIG. 5 displays a sample data set where the number of detected droplets is plotted as a histogram versus a measure of photoluminescence intensity. The data indicates a peak in droplet counts at an amplitude of just less than 300, and several peaks of different intensity positives from about 500 to 700. The different intensity of the positives is the result of different initial target concentrations. The peak at about 500 represents one initial target copy in a droplet, the peak at about 600 represents two initial copies, and so on until the peaks become indistinguishable.

We can define an initial number of copies K after which there is no difference in detection probability. We can now define a variable, X, describing the probability that a given photoluminescence measurement will be defined as a positive detection (X=1). As Equation (9) below indicates, this is defined to be the sum of the probabilities of a droplet containing any distinguishable positive (first term right hand side) plus the saturated positives (second term right hand side), plus the negatives that are incorrectly identified as positives (third term right hand side):

$${P}_{measurement} ( X = 1 ) = {\sum }_{1 \leq i < K} {P}_{{d}_{i}} P ( k = i ) + {P}_{{d}_{K}} P ( k \geq K ) + {P}_{fa} P ( k = 0 ) \qquad ( 9 )$$

This can also be written in terms of A, by substituting Equation (8) for the Poisson probabilities:

$${P}_{measurement} ( X = 1 ) = {\sum }_{1 \leq i < K} {P}_{{d}_{i}} \frac{{λ}^{i} Exp ( - λ )}{i !} + {P}_{{d}_{K}} \{ 1 - {\sum }_{O \leq i \leq K} \frac{{λ}^{i} Exp ( - λ )}{i !} \} + {P}_{fa} Exp ( - λ ) \qquad ( 10 )$$

The probability that a given measurement will be defined as a negative (X=0) can also be defined as:

Pₘₑₐₛᵤᵣₑₘₑₙₜ(X=0)=1−Pₘₑₐₛᵤᵣₑₘₑₙₜ(X=1) (11)

The equations above are simplified for an apparatus where K=1, i.e., where one or more target copies per droplet fall within the same photoluminescence peak or the separation between positive and negatives is so clear that P_{fa} can be neglected. In some cases, however, there may be significant overlap between photoluminescence peaks of the negative droplets and the positive droplets, so that P_{fa} is not negligible. This example applies in either case.

The mean of the variable X is the sum of the product of the realizations and the probabilities:

Mₘₑₐₛᵤᵣₑₘₑₙₜ=1(P(X=1))+0(P(X=0))=P(X=1) (12)

or

$${M}_{measurement} = {\sum }_{1 \leq i \leq K} {P}_{{d}_{i}} \frac{{λ}^{i} Exp ( - λ )}{i !} + {P}_{{d}_{K}} \{ 1 - {\sum }_{O \leq i \leq K} \frac{{λ}^{i} Exp ( - λ )}{i !} \} + {P}_{fa} Exp ( - λ ) \qquad ( 13 )$$

and its standard deviation is given by

$${E}_{measurement} = \sqrt{\begin{matrix}{P}_{measurement} ( X = 1 ) {( 1 - {M}_{measurement} )}^{2} + \\ {P}_{measurement} ( X = 0 ) {M}_{measurement}^{2}\end{matrix}} \qquad ( 14 )$$

Because the definition of X is such that a negative droplet corresponds to X=0 and a positive droplet corresponds to X=1, the mean of X is also the fraction of positive droplets:

$${M}_{measurement} = \frac{{N}_{+}}{N} \qquad ( 15 )$$

Equations (13) and (14) can then be rewritten:

$$\begin{matrix}\frac{{N}_{+}}{N} = {\sum }_{1 \leq i < K} {P}_{{d}_{i}} \frac{{λ}^{i} Exp ( - λ )}{i !} + {P}_{{d}_{K}} \{ 1 - {\sum }_{O \leq i \leq K} \frac{{λ}^{i} Exp ( - λ )}{i !} \} + {P}_{fa} Exp ( - λ ) \\ and & ( 16 ) \\ {E}_{measurement} = \sqrt{( 1 - \frac{{N}_{+}}{N} ) \frac{{N}_{+}}{N}} & ( 17 )\end{matrix}$$

Because of their high degree of non-linearity, Equations (16) and (17) cannot be readily used to find λ without prior knowledge of the probabilities P_{di} and P_{fa}. A special case occurs when all droplets are detected (P_{di}=1), only one photoluminescent state is distinguishable (K=1), and the positive and negative peaks are easily discernible so that the probability of a false detection is negligible (P_{fa}=0). In this case, Equation (16) can be solved for λ:

$$λ = ln ( 1 + \frac{{N}_{+}}{{N}_{-}} ) \qquad ( 18 )$$

Assuming the average droplet volume V_{d} is known, the mean target concentration of the replicate is then m=λ/V_{d}. Continuing the assumption of a Poisson distribution of target within the droplets, the Poisson variance of target concentration for the replicate is equal to its mean value.

At step 408, method 400 includes calculating a weighted mean target concentration for the plurality of replicates, based on the mean target concentration and the variance of target concentration for each replicate. This step may be performed in a manner similar to step 206 of method 200, i.e., where the weight of each mean target concentration (in other words, the statistical weight of each replicate) is defined as the reciprocal of its variance.

At step 410, method 400 includes estimating a real-world variance associated with the target concentration corresponding to each replicate. This step may include, for example, comparing a measure of concentration fluctuations around the weighted mean target concentration to a number of degrees of freedom of the plurality of replicates, as described previously. The real-world variance may be corrected by applying a correction factor that depends on the weight of each replicate, for example, as described above with respect to step 210 of method 200.

At step 412, method 400 includes calculating a meta-replicate weighted mean target concentration and a meta-replicate variance of target concentration, based on the estimated real-world variance, the mean target concentration and the variance of target concentration for each replicate. This may involve the same or a similar calculation.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

We claim:

1. A method of generating a meta-replicate corresponding to a plurality of sample-containing replicates, comprising:
preparing at least two replicates, each containing a plurality of sample-containing droplets, the sample including a target;
determining a mean target concentration and a variance of target concentration for the droplets of each replicate;
estimating a real-world variance of the target concentration; and
calculating a meta-replicate mean target concentration and a meta-replicate variance of target concentration based on the estimated real-world variance.

2. The method of claim 1, wherein determining the mean target concentration of each replicate includes measuring photoluminescence of each sample-containing droplet within the replicate, determining a target concentration in each sample-containing droplet within the replicate based on the measured photoluminescence, and calculating the mean target concentration of the replicate by assuming that the target concentration in the sample-containing droplets within the replicate follows a particular statistical distribution function.

3. The method of claim 2, wherein the particular statistical distribution function is the Poisson distribution function.

4. The method of claim 1, wherein estimating the real-world variance of the target concentration includes calculating a weighted mean target concentration for a plurality of the replicates, calculating a measure of fluctuation of target concentrations around the weighted mean, and calculating an estimate of real-world variance based on the measure of fluctuation.

5. The method of claim 4, wherein calculating the meta-replicate mean target concentration and the meta-replicate variance of target concentration includes calculating the variance for each of the plurality of replicates, calculating a redefined weight for each replicate based on its variance, and determining the meta-replicate mean target concentration and the meta-replicate variance of target concentration based on the redefined weights.

6. The method of claim 1, further comprising estimating real-world measurement error by comparing the meta-replicate variance of target concentration based on the estimated real-world variance with an estimate of variance of meta-data in the presence of only Poisson error.

7. A system for estimating target concentration in a sample-containing fluid, comprising:
a plurality of replicates, each containing a plurality of sample-containing droplets, the sample including a target;
a detector configured to measure photoluminescence emitted by the droplets; and
a processor configured to determine a mean target concentration and a variance of target concentration for each of the replicates, based on photoluminescence measurements of the detector, and further configured to determine a meta-replicate mean target concentration and a meta-replicate variance of target concentration, based on the mean target concentration and the variance of target concentration for the replicates.

8. The system of claim 7, wherein the processor is configured to determine a target concentration in each sample-containing droplet within the replicates based on the measured photoluminescence, and to calculate the mean target concentration of each replicate by assuming that the target concentration in the sample-containing droplets within the replicates follows a particular statistical distribution function.

9. The system of claim 8, wherein the distribution function is the Poisson distribution function.

10. The system of claim 7, wherein the processor is configured to estimate a meta-replicate variance of target concentration in the presence of only Poisson error, and to estimate a variance of target concentration due to real-world error by comparing the meta-replicate variance of target concentration in the presence of only Poisson error to the meta-replicate variance of target concentration.

11. The system of claim 10, wherein the processor is further configured to calculate a weighted mean target concentration for each of the replicates, and wherein estimating the variance of target concentration due to real-world error includes calculating target concentration fluctuations around the weighted mean.

12. The system of claim 11, wherein the processor is further configured to calculate revised weights for each replicate based on the variance of target concentration due to real-world error, and wherein calculating the meta-replicate mean target concentration and the meta-replicate variance of target concentration is performed using the revised weights.

13. A method of reducing effective statistical variance of a concentration of target in a digital assay, comprising:
preparing a plurality of replicates, each containing a known amount of a sample-containing fluid, wherein the sample-containing fluid includes aqueous sample-containing droplets;
measuring photoluminescence of the sample-containing droplets of each of the replicates;
calculating a mean target concentration and a variance of target concentration for each replicate, based on the photoluminescence of the sample-containing droplets of the replicate;
calculating a weighted mean target concentration for the plurality of replicates, based on the mean target concentration and the variance of target concentration for each replicate;
estimating a real-world variance associated with the target concentration corresponding to each replicate; and
calculating a meta-replicate weighted mean target concentration and a meta-replicate variance of target concentration, based on the estimated real-world variance, the mean target concentration, and the variance of target concentration for each replicate.

14. The method of claim 13, wherein photoluminescence of the sample-containing droplets indicates whether or not a nucleic acid target has been amplified through polymerase chain reaction.

15. The method of claim 13, wherein the sample-containing droplets have unknown individual volumes.

16. The method of claim 13, wherein a probability of each sample-containing droplet containing a certain number of copies of a target is modeled by a Poisson distribution function.

17. The method of claim 13, wherein estimating the real-world variance includes comparing a measure of concentration fluctuations around the weighted mean target concentration to a number of degrees of freedom of the plurality of replicates.

18. The method of claim 13, wherein estimating the real-world variance includes comparing the calculated meta-replicate variance of target concentration with an estimate of meta-replicate variance of target concentration in the presence of only Poisson error.

19. The method of claim 13, wherein calculating the weighted mean target concentration includes defining a weight of each replicate as a reciprocal of its variance of target concentration.

20. The method of claim 19, wherein estimating the real-world variance includes applying a correction factor that depends on the weight of each replicate.
